(19) United States
(12) Patent Application Publication
(10) Pub. No.: US 2021/0135892 A1
(43) Pub. Date: May 6, 2021

(54) Automatic Detection Of Presentation Surface and Generation of Associated Data Stream

(71) Applicant: Microsoft Technology Licensing, LLC, Redmond, WA (US)

(72) Inventors: Arash Ghanaie-Sichanie, Woodinville, WA (US); Henrik Turbell, Redmond, WA (US); David Zhao, Redmond, WA (US)

(73) Assignee: Microsoft Technology Licensing, LLC, Redmond, WA (US)

(21) Appl. No.: 16/672,200

(22) Filed: Nov. 1, 2019

(51) Int. Cl. H04L 12/18; H04N 7/14; H04N 5/232

(52) U.S. Cl. CPC H04L 12/1818; H04N 5/23238; H04N 7/142; H04L 12/1831

(57) ABSTRACT

Techniques for automatic detection of a presentation surface and generation of an associated data stream include receiving, in connection with a communication session, a first media stream capturing a portion of an environment including a presentation surface; detecting the presence in the first media stream of the presentation surface; detecting usage of the presentation surface during the conferencing session; generating, in response to the detected usage of the presentation surface, a second media stream dedicated to the presentation surface from the first media stream; and transmitting the second media stream dedicated to the presentation surface to one or more recipient devices.

### CROSS-REFERENCE TO RELATED APPLICATION

This application is related to Attorney Docket Number 170101-463 (407503-US-NP), concurrently filed herewith and titled “Teleconferencing Device Capability Reporting and Selection,” and to Attorney Docket Number 170101-464 (407513-US-NP), concurrently filed herewith and titled “Throttling and Prioritization for Multichannel Audio and/or Multiple Data Streams for Conferencing.” The entire contents of the above-referenced applications are incorporated herein by reference.

### BACKGROUND

Teleconferencing systems provide users with the ability to conduct productive meetings while located at separate locations. Teleconferencing systems may capture audio and/or video content of an environment in which the meeting is taking place to share with remote users and may provide audio and/or video content of remote users so that meeting participants can more readily interact with one another. There are significant areas for new and approved mechanisms for facilitating more immersive and productive meetings.

### SUMMARY

An example data processing system according to a first aspect of the invention include a processor; and a computer-readable medium. The computer-readable medium stores executable instructions for causing the processor to perform operations comprising receiving, in connection with a communication session, a first media stream capturing a portion of an environment including a presentation surface; detecting the presence in the first media stream of the presentation surface; detecting usage of the presentation surface during the conferencing session; generating, in response to the detected usage of the presentation surface, a second media stream dedicated to the presentation surface from the first media stream; and transmitting the second media stream dedicated to the presentation surface to one or more recipient devices.

An example method executed by a data processing system for conducting a communication session according to a second aspect of the invention includes: receiving, in connection with a communication session, a first media stream capturing a portion of an environment including a presentation surface; detecting via a processor the presence in the first media stream of the presentation surface; detecting via the processor usage of the presentation surface during the conferencing session; generating via the processor, in response to the detected usage of the presentation surface, a second media stream dedicated to the presentation surface from the first media stream; and transmitting the second media stream dedicated to the presentation surface to one or more recipient devices.

An example memory device according to a third aspect of the invention stores instructions that, when executed on a processor of a computing device, cause the computing device to conduct a communication session, by: receiving, in connection with a communication session, a first media stream capturing a portion of an environment including a presentation surface; detecting the presence in the first media stream of the presentation surface; detecting usage of the presentation surface during the conferencing session; generating, in response to the detected usage of the presentation surface, a second media stream dedicated to the presentation surface from the first media stream; and transmitting the second media stream dedicated to the presentation surface to one or more recipient devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 presents an example environment in which a communication session according to the techniques disclosed herein may be used;

FIG. 2 is a diagram that an example source device and the console, such as those illustrated in FIG. 1.

FIG. 3 is a flow diagram of an example process for conducting a communication session;

FIG. 4 is a flow diagram of another example process for conducting a communication session;

FIG. 5 is a block diagram illustrating an example software architecture, various portions of which may be used in conjunction with various hardware architectures herein described, which may implement any of the features herein described; and

FIG. 6 is a block diagram illustrating components of an example machine configured to read instructions from a machine-readable medium and perform any of the features described herein.

FIG. 7A illustrates an example in which a whiteboard has been detected in a media stream captured by a camera of the source device.

FIG. 7B illustrates an example in which a transparent representation of a person is displayed over the presentation surface of the whiteboard in which occluded content is made at least partially visible;

FIG. 8 is an example of an example of a stitched high-resolution panoramic image that includes participants present in the environment in which a communication session is being conducted;

FIG. 9 is diagram of a user interface that may be used to display multiple media streams associated with a communication session.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques are disclosed herein for recognizing a presentation surface in a media stream capturing a portion of an environment in which a conferencing session is being conducted. The environment may be a conference room or other location in which at least one participant to the communication session is physically present. Additional participants to the communication session may be located remotely from environment in which the communication session is being conducted. Participants may receive media streams comprising audio, video, images, text, and/or a combination thereof. These media streams can include media streams which are associated with each of the participants of the communication session, whether the participants are physically present in the environment in which the communication session is being conducted or are remote participants. The conferencing system may be configured to generate a media stream associated with each of the participants of the communication session and display the media streams associated with other participants on a computing device associated with each of the remote users. The conferencing system may also include one or more display devices which may display media streams associated with remote device.

The communication system is configured to provide an immersive user experience for participants that are physically located in the environment in which the conferencing system is located as well as for remote users. One aspect of this immersive user experience includes capturing and sharing subjects of interest that are physically present in the environment in which the conferencing system is located. Such objects of interest may include whiteboards, note pads, and/or other objects that have a presentation surface on which notes, diagrams, and/or other content related to the communication session may be written or drawn by a participant. Other objects of interest may be a physical object that may or may not have a presentation surface and may or may not have a presentation surface that is a writing surface, such as a model, a chart, a diagram, or other object that may be related to subject matter discussed in the communication session. How to recognize and share such objects of interest with remote participants to the teleconferencing system has been a significant technical problem. Many times, remote users may not be able to see such or see very clearly such objects. The techniques disclosed herein provide a technical solution for these problems by detecting such an object in the environment in which the communication session is occurring and generating a dedicated media stream for the object for at least portion of the communication session. Remote users can receive a high-resolution media stream of the whiteboard or presentation surface or an object of interest that allows the remote users to fully participate in the conferencing session without missing important details. The examples that follow illustrate these concepts.

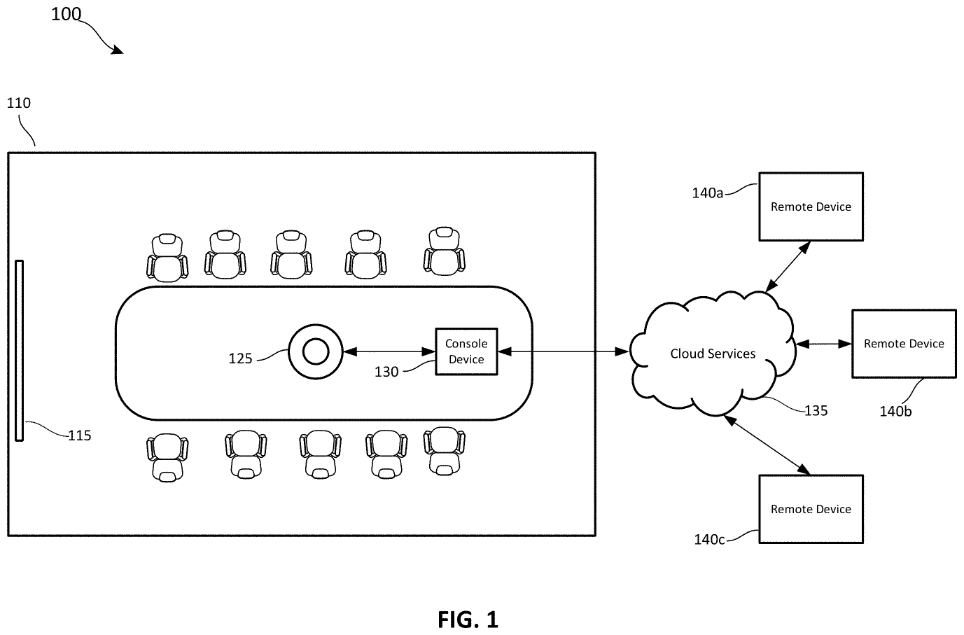

FIG. 1 presents an example environment 100 in which a communication session may be may take place. The environment 100 may comprise a meeting room 110 or other area dedicated to conducting meetings, as in the example environment 100 illustrated in FIG. 1 or may be another space in which at least one participant may be physically present and in which the conferencing system components may be located. The conferencing system in this example includes a source device 125 (also referred to herein as an “endpoint device”), and a console device 130. In the example implementation illustrated in FIG. 1, there is a single source device 125 communicably coupled with the console 130. In other implementations, multiple source devices may be present in the environment from which the communication session is being conducted. One or more remote devices, such as the remote device 140a-140c, may be associated with the conferencing system and provide a user interface that enables remote participants to a communication session to receive one or more media streams associated with the communication session from the source device 125.

The console device 130 is communicably coupled to the cloud services 135 via one or more wired and/or wireless network connections. The cloud services 135 may comprise one or computer servers that are configured to facilitate various aspects of a communication session. The cloud services 135 may be configured to coordinate the scheduling and execution of a communication session. The cloud services 135 may be configured to facilitate routing media streams provided by source devices, such as the source device 125, to receiver devices, such as the remote devices 140a-140c.

While the source device 125 is illustrated as a desktop or tabletop computing device in the example embodiments disclosed herein, the source device 125 is not limited to such a configuration. In some implementations, the functionality of the console device 130 may be combined with that of the source device 125 into a single device. The functionality of the source device 125 may be implemented as a portable electronic device, such as a mobile phone, a tablet computer, a laptop computer, a portable digital assistant device, a portable game console, and/or other such devices. The source device 125 may also be implemented in computing devices having other form factors, such as a vehicle onboard computing system, a video game console, a desktop computer, and/or other types of computing devices.

The remote devices 140a-140c are computing devices that may have the capability to present one or more type of media stream provided by the source device 125, such as media streams that comprise audio, video, images, text content, and/or other types of media stream. Each of the remote devices 140a-140c may have different capabilities based on the hardware and/or software configuration of the respective remote device. While the example illustrated in FIG. 1 includes three remote devices, a communication session may include fewer than three remote devices or may include more than three remote devices. The remote devices 140a-140c may be implemented as a portable electronic device, such as a mobile phone, a tablet computer, a laptop computer, a portable digital assistant device, a portable game console, and/or other such devices. The remote devices 140a-140c may also be implemented in computing devices having other form factors, such as a vehicle onboard computing system, a video game console, a desktop computer, and/or other types of computing devices.

The meeting room 110 also includes a whiteboard 115 which includes a presentation surface upon which participants of the meeting may take notes, draw diagrams, sketch ideas, and/or capture other information related to the communication session. While the example illustrated in FIG. 1 includes a whiteboard, the source device 125 may be configured to detect and capture a media stream for other types of presentation surfaces, such as a note pad or other object that includes a presentation surface. In some implementations, the whiteboard or other presentation surface may be in a fixed location similar to the whiteboard 115 illustrated in FIG. 1. In other implementations, the whiteboard or other presentation surface may not have a fixed location. For example, a whiteboard or notepad may be placed on an easel or stand that may be moved to different locations within the environment in which the communication session takes place. A notepad, note paper, or other similar presentation surface may rest on a conference room table or other such surface. Some implementations may not include such a presentation surface that may be detected by the source device 125 and included as a media stream in a communication session.

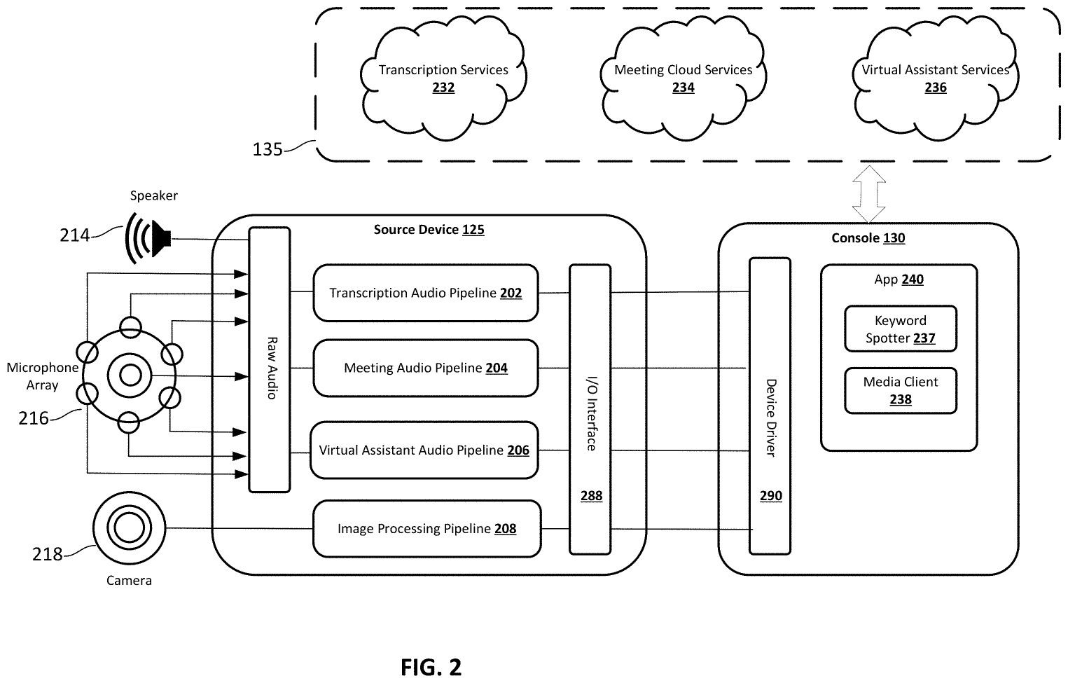

FIG. 2 is a diagram that provides additional details of the source device 125, the console 130, and the cloud services 135. The source device 125 is configured to capture audio and/video signals to generate media streams that may be processed by the source device 125, the console 130, the cloud services 135, or a combination thereof. The cloud services 135 may process the media streams further as will be discussed in the examples that follow and/or may selectively route one or more media streams to the receiver devices 140a-140c. The source device 125 illustrated in FIG. 2 includes three audio pipelines for processing audio captured by the source device 125, including a transcription audio pipeline 202, a meeting audio pipeline 204, and a virtual assistant audio pipeline 206. The source device 125 also includes an image processing pipeline 208 for processing images and video content. The audio and image processing pipelines of the example implementation of FIG. 2 are intended to illustrate some of the types of audio and/or image processing that the source device 125 may perform to produce various types of media streams for a communication session. Other types of processing pipelines may be included in other implementations of the source device in addition to or instead of one or more of the processing pipelines in this example implementation. Furthermore, the source device 125 is discussed as being configurable to produce various types of media streams that may be provided to the cloud services 135 and/or to the receiver devices participating in a communication session. The media streams discussed herein are intended to illustrate examples of some of the types of media streams that may be generated by the source device 125. Other implementations may be configured to generate other types of media streams in addition to or instead of one or more of the media streams discussed in this example.

The source device 125 may include a speaker 214, a microphone array 216, and a camera 218. The source device 125 may be configured to output audio content associated with the communication session via the speaker 214. The audio content may include speech from remote participants and/or other audio content associated with the communication session. The microphone array 216 includes a plurality of microphones that may be used to capture audio from the environment in which the communication session occurs. The use of a microphone array to capture audio may be used to obtain multiple audio signals that can be used to determine directionality of a source of audio content. The audio signals output by the microphone array 216 may be analyzed by the endpoint 125, the console 130, the cloud services 135, or a combination thereof to provide various services which will be discussed in greater detail in the examples which follow. The camera 218 may be a 360-degree camera that is configured to capture a panoramic view of the environment in which the communication session occurs. The output from the camera 218 may need to be further processed by the image processing pipeline 208 to generate the panoramic view of the environment in which the source device 125 is located. The source device 125 may also be connected additional microphone(s) for capturing audio content and/or additional camera(s) for capturing images and/or video content. The audio quality of the additional microphone(s) may be different from the audio quality of the microphone array 216 and may provide improved audio quality. The image quality and/or the video quality provided by the additional camera(s) may be different from the image quality and/or the video quality provided by the camera 218. The additional camera(s) may provide improved image quality and/or video quality. Furthermore, the additional cameras may be 360-degree cameras or may have a field of view (FOV) that is substantially less than 360 degrees.

The source device 125 may be configured to process audio content captured by the microphone array 216 in order to provide various services in relation to the communication session. In the example illustrated in FIG. 2, the source device 125 includes audio pipelines for processing audio inputs to produce audio-based media streams and an image processing pipeline to produce image-based and/or video-based media streams. Some implementations of the source device 125 may only be capable of producing audio-based media streams, while other implementations may be capable of producing both audio-based and image-based and/or video-based media stream.

The source device 125 may include a transcription audio pipeline 202. The transcription audio pipeline 202 may be configured to process audio captured by the microphone array to facilitate automated transcriptions of communications sessions. The transcription audio pipeline 202 may perform pre-processing on audio content from the microphone array 216 and send the processed audio content to the transcription services 232 of the cloud services 135 for processing to generate a transcript of the communication session. The transcript of the communication session may provide a written record what is said by participants physically located in the environment at which the communication session occurs and may also include what is said by remote participants using the remote devices 140a-140c. The remote participants of the communication session may be participating on a computing device that is configured to capture audio content and is configured to route the audio content to the transcription services 232 and/or the other cloud services 135. The transcription services 232 may be configured to provide diarized transcripts that not only include what was said in the meeting but who said what. The transcription services 232 can use the multiple audio signals captured by the microphone array 216 to determine directionality of audio content received by the microphone array 216. The transcription services 232 can use these signals in addition to other signals that may be provided by the source device 125 and/or the console 130 to determine which user is speaking and record that information in the transcripts. In some implementations, the transcription audio pipeline 202 may be configured to encode the audio input received from the microphone array using the Free Lossless Audio Codec (FLAC) which provides lossless compression of the audio signals received from the microphone array 216.

The source device may include a meeting audio pipeline 204. The meeting audio pipeline 204 may process audio signals received from the microphone array 216 for generation of audio streams to be transmitted to remote participants of the communication session and for Voice over IP (VOIP) calls for participants who have connected to the communication session via a VOIP call. The audio pipeline 204 may be configured to perform various processing on the audio signals received from the microphone array 216, such as but not limited to gain control, linear echo cancellation, beamforming, echo suppression, and noise suppression. The output from the meeting audio pipeline 204 may be routed to the meeting cloud services 234, which may perform additional processing on the audio signals. The meeting cloud services 234 may also coordinate sending audio-based, image-based. and/or video-based media streams generated by the source device 125 and/or by the computing devices of one or more remote participants to other participants of the communication session. The meeting cloud services 234 may also be configured to store content associated with communication session, such as media streams, participant information, transcripts, and other information related to the communication session.

The source device 125 may include a virtual assistant audio pipeline 206. The virtual assistant audio pipeline 206 may be configured to process audio signals received from the microphone array 216 to optimize the audio signal for automated speech recognition (ASR) processing by the virtual assistant services 236. The source device 125 may transmit the output of the virtual assistant audio pipeline 206 to the virtual assistant services 236 for processing via the console 130. The virtual assistant audio pipeline 206 may be configured to recognize a wake-word or phrase associated with the virtual assistant and may begin transmitting processed audio signals to the virtual assistant services 236 in response to recognizing the wake-word or phrase. The virtual assistant services 236 may provide audio responses to commands issued to via the source device 125 and the responses may be output by the speaker 214 of the source device 125 and/or transmitted to the computing devices of remote participants of the communication session. The participants of the communication session may request that the virtual assistant perform various tasks, such as but not limited to inviting additional participants to the communication session, looking up information for a user, and/or other such tasks that the virtual assistant is capable of performing on behalf of participants of the communication session.

The source device 125 may include an image processing pipeline 208. The image processing pipeline 208 may be configured to process signals received from the camera 218. The camera 218 may be a 360 degrees camera capable of capturing images and/or video of an area spanning 360 degrees around the camera. The camera 218 may comprise multiple lenses and image sensors and may be configured to output multiple photographic images and/or video content having an overlapping field of view. The image processing pipeline 208 may be configured to stitch together the output of each of the images sensors to produce panoramic images and/or video of the environment surrounding the camera 218. The panoramic images and/or video may be processed by the images processing pipeline 208 to produce one or more dedicated media streams for participants of the communication session, the presentation surface, and/or an area of interest. The image processing pipeline 208 may include an encoder for encoding video output from the camera 218 that may use Advanced Video Coding, also referred to as H.264 or MPEG-4 Part 10, Advanced Video Coding (MPEG-4 AVC)

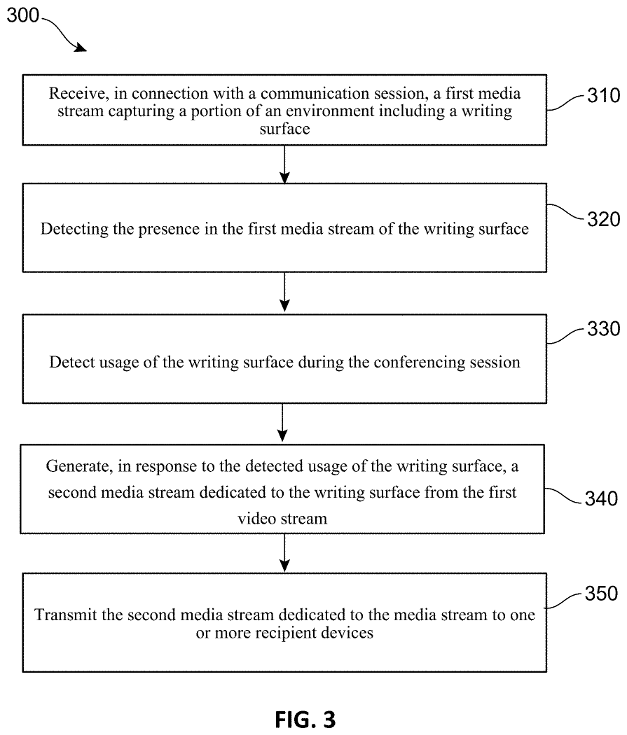

The image processing pipeline 208 may include presentation surface detection logic configured to detect a presentation surface, such as but not limited to one or more whiteboards, one or more notepads (which may comprise a stack of sheets of paper for taking notes which may be torn off or separated from the stack), a chalk board, a glass board, a flipchart board (which may comprise sheets of paper or other writing material that may be flipped out of the way or removed), a cork board, a cardboard, or any other type of board or screen used for writing, drawing, and/or presenting. The presentation surface logic may also determine whether the presentation surface is being used by a participant of the communication session and generate a dedicated media stream for the presentation surface in response to detecting that the presentation surface is being used. Producing a dedicated media stream for the presentation surface provides a technical solution to the technical problem of how to effectively share written or drawn content with remote participants of the communication session. The dedicated media stream can also be saved with other content associated with the communication session to provide participants with access to the written or drawn notes after the meeting is has been completed. Additional details of the presentation surface logic will be discussed with respect to the example process illustrated in FIG. 3.

The image processing pipeline 208 may include segmentation & occlusion logic configured to segment the media stream comprising the whiteboard or other presentation surface into at least a foreground portion, a background portion, and a presentation surface portion. The foreground portion may include objects and/or participants located in the environment in which the communication session is taking place which are occluding at least a portion of the whiteboard or other presentation surface. The segmentation & occlusion logic may be configured recognize when a region of the presentation surface is obscured by a participant to the communication session or object in the environment in which the communication session is taking place and to render a composite image that simulates a view of the obscured content. Additional details of the segmentation & occlusion logic will be discussed with respect to the example process illustrated in FIG. 3.

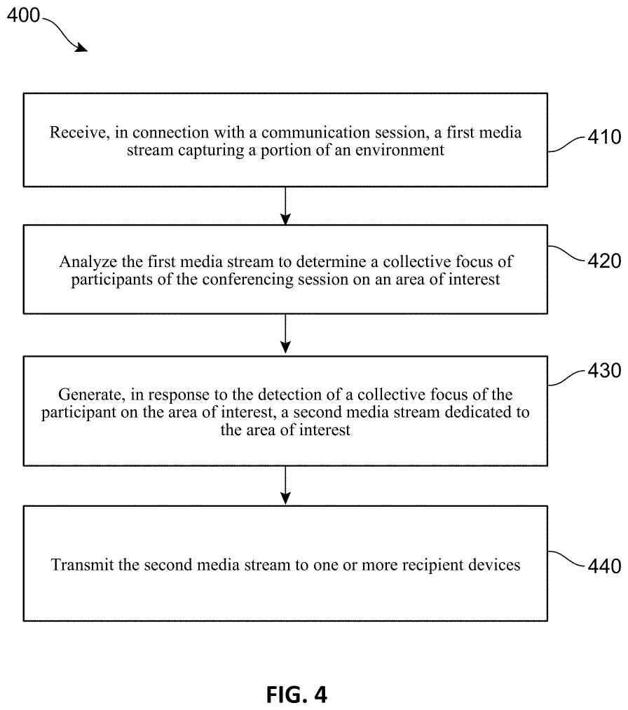

The image processing pipeline 208 may be configured to generate a user interface that may include the multiple media steams. This user interface may be displayed on a display of the console device 130 for participants of the communication session that are present in the meeting room 110. A similar user interface may also be rendered on a display of the receiving devices, such as the remove devices 140a-140c. An example of such a user interface is illustrated in FIG. 9, which illustrates an example active streams interface 900 in which a plurality of media streams may be rendered. The image processing pipeline 208 may be configured to include a plurality of media streams related to at least a subset of participants of the communication session into a single media stream for rendering on the active streams interface 900. The plurality of media streams may be arranged and rendered in a grid or array proximate to one another on a display of a computing device of remote users and/or an source device with display capabilities, such as in the active streams interface 900 illustrated in FIG. 9 which illustrates one possible configuration for such an interface. The active streams interface 900 may include one or more users who are actively speaking, one or more users who are determined to be reacting to an event or content of the communication session. The active streams interface 900 may include a stream dedicated to a whiteboard or other presentation surface and/or to an area of interest that is a focus of user attention. In some implementations, the image processing pipeline 208 may render the active streams interface 900 as an additional media stream that may be rendered on a display of a receiving device. Additional features of the image processing pipeline 208 of the source device 125 will be discussed with respect to FIGS. 3 and 4 which follow.

The console 130 may comprise a computing device that may serve as a communication relay between the source device 125 and the cloud services 135. The source device 125 may include an input/output (I/O) interface 288 that provides a wired and/or wireless connection between the source device 125 and the console 130. In some implementations, the I/O interface may comprise a Universal Serial Bus (USB) connector for communicably connecting the source device 125 with the console 130. In some implementations, the console may comprise a general-purpose computing device, such as a laptop, desktop computer, and/or other computing device capable of communicating with the source device 125 via one or more device drivers 290. The console 130 may include an application 240 that is configured to relay data between the source device 125 and the cloud services 135. The application 240 may comprise a keyword spotter 237 and a media client 238. The keyword spotter 237 may be configured to recognize a wake word or a wake phrase that may be used to initiate a virtual assistant, such as but not limited to Microsoft Cortana. The wake word or wake phrase may be captured by the microphone array 216. Once the wake word has been detected, the console 130 may route an audio stream from the virtual assistance audio pipeline 206 to the virtual assistant services 236 for processing.

The media client 238 may be configured to provide a user interface that allows users to control one or more operating parameters of the source device 125. For example, the media client 238 may allow a user to adjust the volume of the speaker 214, to mute or unmute the microphone array 216, and/or to turn the camera 218 on or off. Muting the microphone array 216 will cause remote participants to be unable to hear what is occurring in the conference room or other environment in which the communication session is based. Turning off the camera 218 will halt the generation of individual media streams for each of the participants in the conference room or other environment and other media streams of the environment so that remote participants will be unable to see what is occurring in the conference room or environment in which the communication session is based. The media client 238 may also enable a user to turn on or off the transcription facilities of the conferencing system, and to turn on or turn off recording of audio and/or video of the communication session.

The media client 238 may be configured to coordinate the output of media streams from the source device 125. The media client 238 may receive stream requests from the cloud services 135, the console 130, and/or from other source devices for generation of a specific stream. For example, the cloud services may be configured to request an audio stream that has been optimized for use with the transcription services 232 or an audio stream that has been optimized for use with the virtual assistant services 256. The media client 238 may be configured to receive various streams of content and/or data from one or more components of the image processing pipeline 208. The media client 238 may also be configured to receive data from other components the source device 125, the console 130, the cloud services 135, and/or other source devices, and may be configured to send one or more data streams to one or more of these devices.

FIG. 3 is a flow diagram of an example process 300 for conducting a communication session. The process 300 may be implemented by the source device 125. The image processing pipeline 208. and more specifically, the presentation surface detector logic and the segmentation & occlusion processing logic of the image processing pipeline 208 may be used to implement the process 300. The source device 125 may he configured to detect the presence of a whiteboard 115 or other presentation surface that is in use during a communication session and to create a dedicated media stream for the whiteboard or other presentation surface. The dedicated media stream may be transmitted by the source device 125 to one or more recipient devices, such as the cloud services 135, which may in turn distribute the dedicated media stream to the computing devices of participants of the communication session. The dedicated media stream can make it easier for remote participants of the communication session to see what is being written on the white board or other presentation surface. Furthermore, the dedicated media stream may be captured by the teleconferencing system, so that a record of what was written on the white board or other presentation surface may be automatically captured for later reference with the other content that the teleconferencing system records and/or generates for a communication session.

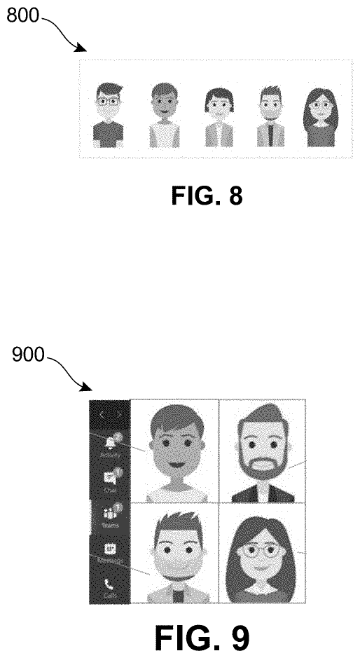

The process 300 may include an operation 310 in which a first media stream capturing a portion of an environment including a presentation surface is received in connection with a communication session. The source device 125 is configured to capture at least a portion of the environment in which the communication session is taking place using the camera 214. The image processing pipeline 208 may be configured to process the output of the camera 214 and to generate panoramic images and/or video of the environment surrounding the source device 125. FIG. 8 is an example of an example of a stitched high-resolution panoramic image 800 that includes participants present in the environment in Which a communication session is being conducted. The panorama may also capture a presentation surface, such as whiteboard or other such presentation surface if present in the environment in which the communication session is taking place and may include that presentation surface in the panorama along with the participants detected. The images processing pipeline 208 may generate a first media stream that includes the panorama. The media stream may comprise a series of panoramic images and/or panoramic video representing the environment in which the communication session is taking place.

The environment in which the communication session may include a whiteboard, a notepad, or other presentation surface on which participants to the communication session may take notes, draw figures, draft outlines, or capture other written or drawn content associated with the communication session. The whiteboard, notepad, or other object may be located at a fixed location within the environment or may be a portable or moveable object that may be moved around within the environment. The first media stream of the environment may capture the presentation surface.

The process 300 may include an operation 320 in which the presence of the presentation surface is detected in the first media stream. The image processing pipeline 208 may be configured to analyze the first media stream to identify the presentation surface. The image processing pipeline 208 may be configured to identify multiple presentation surfaces in the first media stream. The environment in which the communication session is taking place may have multiple presentation surfaces available, including but not limited to one or more whiteboards, one or more notepads (which may comprise a stack of sheets of paper for taking notes which may be torn off or separated from the stack), a chalk board, a glass board, a flipchart board (which may comprise sheets of paper or other writing material that may be flipped out of the way or removed), a cork board, a cardboard, or any other type of board or screen used for writing, drawing, and/or presenting.

The image processing pipeline 208 may be configured to use various means for detecting the presence of a presentation surface. The image processing pipeline 208 may be configured to analyze the first media stream for the presence of a quadrilateral. The image processing pipeline 208 may make the assumption that a presentation surface may generally be rectangular or square in shape with four sides. The image processing pipeline 208 may be configured to perform edge detection, corner detection, or both in an attempt to detect the presence of a presentation surface. Depending on the environment in which the target is located, this may be challenging because there may be missing or occluded edges and corners, there may be heavy reflection on the board, there may be other rectangular objects in the scene, and the like. To ensure a high-level understanding of the scenes in which a physical target such as a board may be present, in one implementation a trained Machine Learning (ML) model may be used. For example, a deep convolutional neural network for semantic segmentation of presentation surface pixels may be trained and used as part of the process. The input to the network may be color images and the output may classify each pixel in the color image into one of three classes: foreground, presentation surface, or background. The foreground may consist of persons, chairs and other occluding objects. The background may consist of walls, floor, ceiling, or other elements in the environment that are not a presentation surface. Training data of such a network may contain photos of meeting room environments, with corresponding segmentation maps where each pixel is classified into one of the three classes. It is also possible to use synthetically rendered images using 3D computer graphics. The rendering can generate perfect segmentation maps.

In one implementation, the deep convolutional neural network may be a network that has an encoder-decoder structure with shortcut connections between corresponding pyramid levels. Details of such encoder-decoder structures are discussed by Sandler et al “MobileNetV2: Inverted Residuals and Linear Bottlenecks”, The IEEE Conference on Computer Vision and Pattern Recognition (CVPR), 2018, pp. 4510-4520, entirety of which is incorporated by reference herein. In an example, the input image may be down-sampled (e.g., 288×160 pixels). As a result, the trained network may output a classification map of the same resolution.

The classification map may then be used to locate edges in the image. Edges between background and the presentation surface may be kept, whereas edges to foreground objects may be ignored. The rough direction of each edge pixel may then be computed, separating edges into the four main edge directions of the presentation surface (top, right, down, left). For each direction, a random sample consensus (RANSAC) line fitting operation may then be performed. The intersections of the located edge directions may then be computed to form a first estimate of the presentation surface's quadrilateral. Edges outside this quadrilateral may be removed and line fitting may be performed iteratively, as needed, for a more accurate estimate.

The use of a deep convolutional neural network approach as described above can provide improved edge detection by better distinguishing presentation surface edges from other edges in the image (e.g., wall corners, lines drawn on the presentation surface, patterns on the floor and the like).

The image processing pipeline 208 may be configured to confirm with a participant to the communication session that an object identified as a presentation surface is actually a presentation surface and not some other object in the environment that has erroneously been identified as a presentation surface. The image processing pipeline 208 may be configured to include a visual indication of the identification of a presentation surface on a user interface of the console 130 or other computing device located in environment where the communication session is taking place. The image processing pipeline may dynamically draw boundary lines on the presentation surface to be included in a media stream of the environment displayed to the participant of the communication session. The boundary lines may help a participant to the communication session determine if a presentation surface is being correctly identified. In an example, a participant to the meeting may be able to indicate via a user interface element whether the method correctly identified the presentation surface. The user interface may be presented on a display of the console 130, on another display present in the environment that is configured to present content related to the communication session, and on a display of a computing device of one or more remote participants to the communication session.

The process 300 may include an operation 330 in which the usage of the presentation surface during the communication session is detected. The image processing pipeline 208 may be configured to segment at least a portion of the first media stream into a foreground portion, a background portion, and a presentation surface portion. The image processing pipeline 208 may utilize a trained machine learning model to perform this segmentation. In one implementation, a deep convolutional neural network for semantic segmentation of board pixels may be trained and used as part of the segmentation process. The input to the network may be color images or video captured by the camera 214 and the output may classify each pixel in the color image into one of three classes: foreground pixels, presentation surface pixels, or background pixels. The foreground portion may consist of persons, chairs and other objects that may occlude at least a portion of the presentation surface. The background portion may consist of walls, floor, ceiling, a table or other elements of the environment in which the presentation surface may be disposed on or in front of. The presentation surface portion may consist of at least a portion of the presentation surface that has been determined to not be a foreground element or background element. The machine learning model may also be configured to distinguish between persons and objects in the foreground. The image processing pipeline 208 may be configured to determine that the presentation surface is being used when a participant moves to occlude at least a portion of the presentation surface from a position where the user was not previously occluding at least a portion of the presentation surface, and where the person remains in a position occluding at least a portion of the presentation surface for longer than a predetermined threshold. This threshold check may be performed to avoid accidentally triggering a determination that a participant to the communication session is using the presentation surface if the user merely passes between the camera and presentation surface.

The process 300 may include an operation 340 in which, in response to the detected usage of the presentation surface, a second media stream dedicated to the presentation surface is generated. The second media stream may be generated by extracting a portion of the first media stream which captures the presentation surface it its entirety or substantially in its entirety. The image second media stream may include various processing to enhance the visibility of the presentation surface. For example, the image processing pipeline 208 may be configured to determine that content of a region of the presentation surface is being obscured by an object or person, to identify content associated with the obscured region, and to overlaying a transparent representation of the object or person over a representation of the content of the region obscured by the object or person. This technique allows the communication system to provide at least a partial view of the content of the obscured region of the presentation surface. As the participant moves about to write, draw, or otherwise interact with the presentation surface different regions of the presentation surface may be obscured, the image processing pipeline 208 may be configured to update formerly obscured regions with fresh content as formerly obscured areas become unobscured.

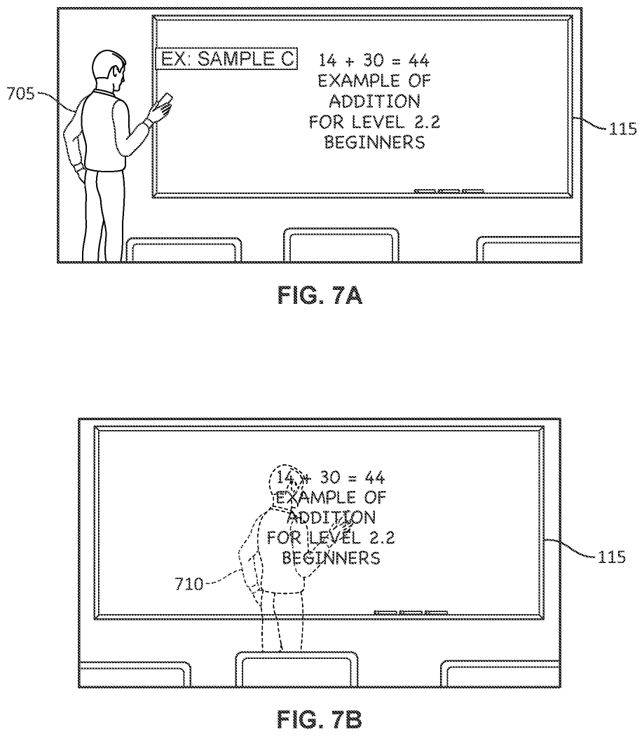

FIG. 7A illustrates an example in which a whiteboard 115 has been detected. A participant 705 of the conferencing session has also been detected in foreground, which may indicate that the participant 705 is going to use a presentation surface of the whiteboard 115. The image processing pipeline 208 may generate a media stream dedicated to the whiteboard 115 responsive to detecting that the participant 705 is using or about to use the whiteboard. The dedicated media stream may be shown on the active streams interface 900, which includes an array or grid of active streams associated with participants to the communication session and/or with objects of interest, such as the whiteboard 115. FIG. 7B illustrates an example of the whiteboard 115 being rendered with a transparent representation 710 of the participant 705 rendered over the whiteboard 115. The contents of the presentation surface of the whiteboard 115 that would otherwise be obscured by the body of participant 705 are rendered based on a set of most recently known contents of the obscured region of the presentation surface. The image processing pipeline 208 may generate a dedicated media stream comprising the transparent representation 710 and the rendering of the obscured content which may be provided to participants of the communication session. The dedicated stream may be included in the active stream interface 900 which may be rendered on a display of a computing device of participants to the communication session.

Referring back to FIG. 3, the process 300 may include an operation 350 in which the second media stream may be transmitted to one or more recipient devices. The second media stream may be transmitted to the cloud services 135 for processing. The meeting cloud services 232 may be configured to distribute the media stream to the computing devices of one or more remote participants of the communication session. The meeting cloud services 232 may also save the second media stream to maintain a record of the contents of the presentation surface during the communication session so that participants may later refer back to the contents of the presentation surface. In some implementations, the meeting cloud services 232 may be configured to extract one or more images of the presentation surface from the media stream and store these images so that participants may later refer back to the contents of the presentation surface as they appeared at different points in time of the communication session.

The image processing pipeline 208 may be configured to detect that the content on the presentation surface has been cleared and may stop generating the dedicated media stream for the presentation surface. Clearing the contents of the presentation surface may have different meaning depending upon the type of presentation surface. Where the content is on a white board, chalkboard, glass board, or other similar presentation surface, the content may be erased to provide a clean presentation surface for additional content to be recorded. Where the content is on a note pad or other surface that is typically cannot be erased or otherwise cleared of content, the sheet of paper or other material of the note pad may be torn away or removed to provide access to a clean presentation surface for additional content may be recorded. Where the content is flip pad, a sheet upon which content has been recorded may be flipped out of the way behind the flip pad to provide access to a new sheet of paper or other material that has a clean presentation surface. The image processing pipeline 208 may detect that contents that were previously identified have been cleared from the presentation surface and may be configured to stop generating the dedicated media stream. The image processing pipeline 208 may be configured to detect that a participant to the communication session has once again used to the presentation surface and may resume the generation of the dedicated media stream associated with the presentation surface. The presentation surface may be fixed at a particular location or may be moveable within the environment in which conferencing session is being conducted. The image processing pipeline 208 may be configured to detect and track the location of the presentation surface throughout the communication session.

The image processing pipeline 208 may also be configured to detect that the contents of the presentation surface have not been modified for at least a predetermined period of time. If the predetermined period of time has elapsed and none of the participants of the communication session have used the presentation surface, then the source device 125 may assume that the current contents may not be relevant to a current portion of the communication session. The image processing pipeline 208 of the source device 125 can deemphasize the content of the presentation surface by stopping the generation of the dedicated media stream associated with the presentation surface. The dedicated media stream may be resumed in response to a participate approaching the presentation surface and/or modifying the contents displayed thereon.

The image processing pipeline 208 may detect that the presentation surface has been used by a detecting an attentional focus of one or more participants of the communication session, determining whether the attentional focus of at least one or more of the one or participants of the conferencing session is directed to the presentation surface. The head and face detector unit 316 of the image processing pipeline 208 may be configured to determine had and/or face positioning of participants of the communication session based on the panoramic image of the environment captured by the camera 214. The image processing pipeline 208 may include head and/or face detection logic may implement a head/face recognition neural network that is trained to identify the location of head and/or faces of participants in the images and/or video input. The neural network can use this information calculate a gaze direction of the participant(s) of the conferencing session to determine whether one or more participants have their attention focused on the presentation surface. The image processing pipeline 208 may start or resume the dedicated media stream associated with the presentation surface in response to the one or more participants having their attention focused on the presentation surface. The image processing pipeline 208 may be configured to stop generating the dedicated media stream for the presentation surface in response to the participants no longer focusing their attention on the presentation surface for more than a predetermined period of time. The image processing pipeline 208 may resume generated the dedicated media stream responsive to the presentation surface becoming a focus of attention once again or in response to a participant approaching the presentation surface to add new content or modify existing content on the presentation surface.

FIG. 4 is a flow diagram of another example process 400 for conducting a communication session. The in the process 400 an area of increased interest may be detected based on a collective focus by multiple participants of the communication session. For example, a speaker may refer to a poster or a model on a stand, and the participants of the communication session that are present in the environment in which the communication session is taking place may shift their focus toward the poster or model. A dedicated video stream may be generated for the area of interest in response to the participants to the communication session shifting their collective focus toward the area of interest.

The process 400 may include an operation 410 in which, in connection with a communication session, a first media stream capturing a portion of an environment is received. As discussed in the preceding examples, the camera 214 of the source device may be a 360-degree camera configured to capture images of an area substantially 360-degrees around the camera. The output from the camera may be stitched together to form a panorama of the environment in which the communication session is occurring. The first media stream may comprise high-resolution images or video of the environment in which the communication session is taking place, and the high-resolution images or video may be used to generate media streams directed to one or more participants, presentation surfaces, and/or areas of interest in the environment.

The process 400 may include an operation 420 in which the first media stream is analyzed to determine a collective focus of participants of the conferencing session on an area of interest. The first media stream may be analyzed to determine whether participants of the communication session have shifted their focus to an area of increased interest. The area of increased interest may be the location of a poster, model, exhibit, or other object that may be a subject of discussion during the communication session.

The image processing pipeline 208 of the source device 125 may be configured to detect the shift in focus based on head pose, eye gaze, and/or gestures by participants of the communication session. The head and/or face detector 316 of the image processing pipeline 208 may be configured to detect the locations of the heads and/or faces of the participants of the communication session based on the location information output by the body detector 316 and the panoramic images and/or video content captured by the camera 214. The head and/or face detector 316 may implement a head/face recognition neural network that is trained to identify the location of head and/or faces of participants in the images and/or video input. The image processing pipeline 208 may be configured to determine whether a threshold number or percentage of the participants of the communication session are focusing on the area of interest. The number or percentage of participants for whom a shift of focus toward the area of interest are required may depend upon the total number of participants present at environment in which the communication session is being conducted. The image processing pipeline 208 may take other factors into consideration when determining whether collective focus has shifted, such as whether an active speaker is determined to be proximate to the area of interest. If the area of interest is offset from a location of the active speaker by more than a predetermined threshold, then the image processing pipeline 208 may determine that there is an area of interest that is proximate to the active speaker and may generate a media stream that includes both the active speaker and the area of interest or separate media streams for the active speaker and the area of interest.

The process 400 may include an operation 430 in which, in response to the detection of a collective focus of the participant on the area of interest, a second media stream dedicated to the area of interest is generated. The second media stream may be generated by extracting a portion of the first media stream which captures the area of interest in its entirety or substantially in its entirety. The area of interest may include a poster, model, exhibit, or other object that is at least temporarily subjected to the collective attentive of at least a portion of the participants of the communication session that are present in the environment from which the communication session is being conducted.

The process 400 may include an operation 440 in which the second media stream is transmitted to one or more recipient devices. The second media stream may be transmitted to the cloud services 135 for processing. The meeting cloud services 232 may be configured to distribute the media stream to the computing devices of one or more remote participants of the communication session. The meeting cloud services 232 may also save the second media stream to maintain a record events occurring during the communication session so that participants may later refer back to what drew participant's attention during the communication session. In some implementations, the meeting cloud services 232 may be configured to extract one or more images of the area of interest from the media stream and store these images so that participants may later refer back to the area of interest is it appeared at different points in time of the communication session. If there is a model, exhibit, or other object at the area of interest, different aspects of the model, exhibit or other object may referenced throughout the communication session, and a user may later refer back to the recorded media stream or images to view what aspects were being referenced at different times throughout the communication session.

The dedicated media stream directed to the area of interest may be stopped if the user focus shifts away from the area of interest. However, the dedicated media stream may be resumed if the focus of attention returns to the area of interest. The threshold number of participants and/or the length of time that that they must focus on the area of interest may be lower than the thresholds used when first determining whether the generate the dedicated media stream.

Examples of the operations illustrated in the flow charts shown in FIGS. 3 and 4 are described in connection with FIGS. 1 and 2. It is understood that the specific orders or hierarchies of elements and/or operations disclosed in FIGS. 3 and 4 are example approaches. Based upon design preferences, it is understood that the specific orders or hierarchies of elements and/or operations in FIGS. 3 and 4 may be rearranged while remaining within the scope of the present disclosure. FIGS. 3 and 4 present elements of the various operations in sample orders and are not meant to be limited to the specific orders or hierarchies presented. Also, the accompanying claims present various elements and/or various elements of operations in sample orders and are not meant to be limited to the specific elements, orders, or hierarchies presented.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

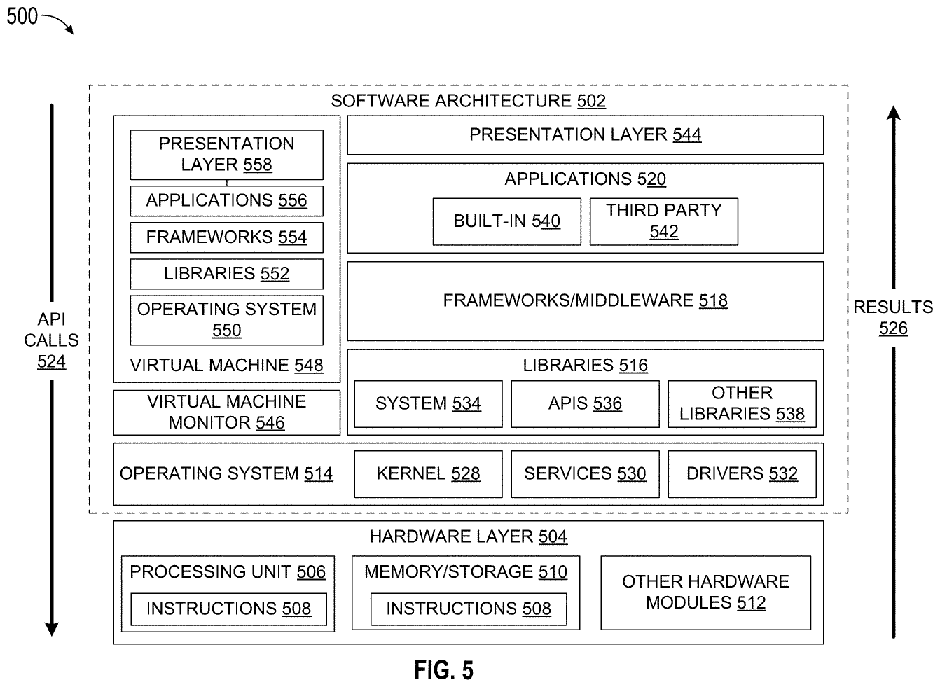

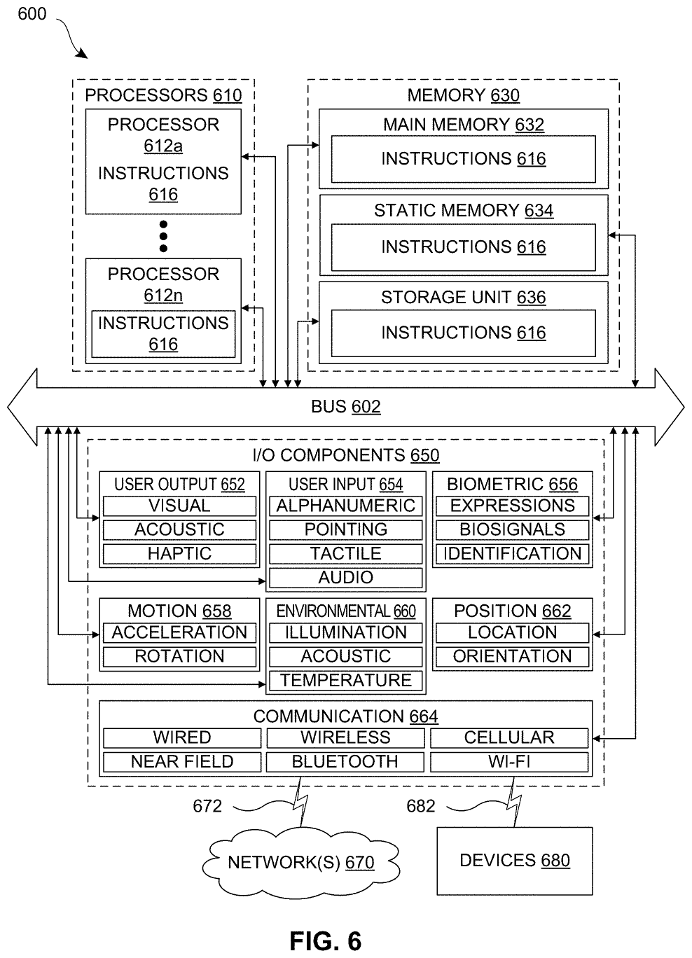

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 508 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 514, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 860, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

In the following, further features, characteristics and advantages of the system and method will be described by means of items: Item 1. A data processing system comprising: a processor; and a computer-readable medium storing executable instructions for causing the processor to perform operations comprising: receiving, in connection with a communication session, a first media stream capturing a portion of an environment including a presentation surface; detecting the presence in the first media stream of the presentation surface; detecting usage of the presentation surface during the conferencing session; generating, in response to the detected usage of the presentation surface, a second media stream dedicated to the presentation surface from the first media stream; and transmitting the second media stream dedicated to the presentation surface to one or more recipient devices.

Item 2. The data processing system of item 1, wherein the memory further comprises instructions configured to cause the processor to perform operations comprising: detecting that content on the presentation surface has been cleared in the first media stream; and stopping generating the second media stream dedicated to the presentation surface responsive to the visible content on the presentation surface having been cleared.

Item 3. The data processing system of item 1, wherein the memory further comprises instructions configured to cause the processor to perform operations comprising: detecting that the visible content of the presentation surface has not been modified for a predetermined period of time since a previous usage of the presentation surface has been detected; and stopping generating the second media stream dedicated to the presentation surface responsive to the note-taking surface having not been used for the predetermined period of time.

Item 4. The data processing system of item 1, wherein the instructions for detecting that the presentation surface has been used by a participant of the meeting session further comprise instructions configured to cause the processor to perform operations comprising: detecting an attentional focus of one or more participants of the communication session; determining whether the attentional focus of at least one of the one or more participants of the meeting session is directed toward the presentation surface; and determining that the presentation surface is being used responsive to the attentional focus of at least one participant being directed toward the presentation surface.

Item 5. The data processing system of item 1, wherein the instructions for generating second the media stream further comprise instructions configured to cause the processor to perform operations comprising: determining that content of a region of the presentation surface is being obscured by an object or person; identifying content associated with the obscured region; and overlaying a transparent representation of the object or person over a representation of the content of the region obscured by the object or person.

Item 6. The data processing system of item 1, wherein the instructions for generating the media stream further comprise instructions configured to cause the processor to perform operations comprising: extracting a portion of the first media stream associated with the presentation surface, wherein the first media stream comprises a panoramic video stream of the communication session.

Item 7. A method executed by a data processing system for conducting a communication session, the method comprising: receiving, in connection with a communication session, a first media stream capturing a portion of an environment including a presentation surface; detecting via a processor the presence in the first media stream of the presentation surface; detecting via the processor usage of the presentation surface during the conferencing session; generating via the processor, in response to the detected usage of the presentation surface, a second media stream dedicated to the presentation surface from the first media stream; and transmitting the second media stream dedicated to the presentation surface to one or more recipient devices.

Item 8. The method of item 7, further comprising: detecting that content on the presentation surface has been cleared in the first media stream; and stopping generating the second media stream dedicated to the presentation surface responsive to the visible content on the presentation surface having been cleared.

Item 9. The method of item 7, further comprising: detecting that the visible content of the presentation surface has not been modified for a predetermined period of time since a previous usage of the presentation surface has been detected; and stopping generating the second media stream dedicated to the presentation surface responsive to the note-taking surface having not been used for the predetermined period of time.

Item 10. The data processing system of item 7, wherein detecting that the presentation surface has been used by a participant of the meeting session further comprises: detecting an attentional focus of one or more participants of the communication session; determining whether the attentional focus of at least one of the one or more participants of the meeting session is directed toward the presentation surface; and determining that the presentation surface is being used responsive to the attentional focus of at least one participant being directed toward the presentation surface.

Item 11. The data processing system of item 7, wherein generating the second media stream further comprises: determining that content of a region of the presentation surface is being obscured by an object or person; identifying content associated with the obscured region; and overlaying a transparent representation of the object or person over a representation of the content of the region obscured by the object or person.

Item 12. The data processing system of item 7, wherein generating the second media stream further comprises: extracting a portion of the first media stream associated with the presentation surface, wherein the first media stream comprises a panoramic video stream of the communication session.

Item 13. A memory device storing instructions that, when executed on a processor of a computing device, cause the computing device to conduct a communication session, by: receiving, in connection with a communication session, a first media stream capturing a portion of an environment including a presentation surface; detecting the presence in the first media stream of the presentation surface; detecting usage of the presentation surface during the conferencing session; generating, in response to the detected usage of the presentation surface, a second media stream dedicated to the presentation surface from the first media stream; and transmitting the second media stream dedicated to the presentation surface to one or more recipient devices.

Item 14. The memory device of item 13, further comprising instructions configured to cause the processor to perform operations comprising: detecting that content on the presentation surface has been cleared in the first media stream; and stopping generating the second media stream dedicated to the presentation surface responsive to the visible content on the presentation surface having been cleared.

Item 15. The memory device of item 14, further comprising instructions configured to cause the processor to perform operations comprising: detecting that the visible content of the presentation surface has not been modified for a predetermined period of time since a previous usage of the presentation surface has been detected; and stopping generating the second media stream dedicated to the presentation surface responsive to the note-taking surface having not been used for the predetermined period of time.

Item 16. The memory device of item 14, wherein the instructions for detecting that the presentation surface has been used by a participant of the meeting session further comprise instructions configured to cause the processor to perform operations comprising: detecting an attentional focus of one or more participants of the communication session; determining whether the attentional focus of at least one of the one or more participants of the meeting session is directed toward the presentation surface; and determining that the presentation surface is being used responsive to the attentional focus of at least one participant being directed toward the presentation surface.

Item 17. The memory device of item 14, wherein the instructions for generating second the media stream further comprise instructions configured to cause the processor to perform operations comprising: determining that content of a region of the presentation surface is being obscured by an object or person; identifying content associated with the obscured region; and overlaying a transparent representation of the object or person over a representation of the content of the region obscured by the object or person.

Item 18. The memory device of item 14, wherein the instructions for generating the media stream further comprise instructions configured to cause the processor to perform operations comprising: extracting a portion of the first media stream associated with the presentation surface, wherein the first media stream comprises a panoramic video stream of the communication session.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a computer-readable medium storing executable instructions, which when executed by the processor, cause the processor to control the data processing system to perform operations comprising:
receiving, in connection with a communication session, a first media stream capturing a portion of an environment;
determining, based on the received first media stream, that the environment includes a presentation surface;
detecting, based on the received first media stream, content written or drawn on the presentation surface during the communication session;
in response to the detected content written or drawn on the presentation surface:
extracting the written or drawn content on the presentation surface from the received first media stream; and
generating a second media stream based on the extracted written or drawn content on the presentation surface; and
transmitting, to a remote device via a communication network, the second media stream including the extracted written or drawn content on the presentation surface.

2. The data processing system of claim 1, wherein the executable instructions further comprise instructions configured to cause the processor to perform operations comprising:
detecting that visible content on the presentation surface has been cleared in the first media stream; and
stopping generating the second media stream including the extracted written or drawn content on the presentation surface responsive to the visible content on the presentation surface having been cleared.

3. The data processing system of claim 1, wherein the executable instructions further comprise instructions configured to cause the processor to perform operations comprising:
detecting that visible content of the presentation surface has not been modified for a predetermined period of time since a previous usage of the presentation surface has been detected; and
stopping generating the second media stream including the extracted written or drawn content on the presentation surface responsive to a note-taking surface having not been used for the predetermined period of time.

4. The data processing system of claim 1, wherein to detect the content written or drawn on the presentation surface, the executable instructions further comprise instructions configured to cause the processor to perform operations comprising:
detecting an attentional focus of one or more participants of the communication session;
determining whether the attentional focus of at least one of the one or more participants of the communication session is directed toward the presentation surface; and
determining that the presentation surface is being used responsive to the attentional focus of the at least one participant being directed toward the presentation surface.

5. The data processing system of claim 1, wherein to generate the second media stream, the executable instructions further comprise instructions configured to cause the processor to perform operations comprising:
determining that content of a region of the presentation surface is being obscured by an object or person;
identifying the content associated with the obscured region; and
overlaying a transparent representation of the object or person over a representation of the identified content associated with the region obscured by the object or person.

6. The data processing system of claim 1, wherein to generate the second media stream, the executable instructions further comprise instructions configured to cause the processor to perform operations comprising:
extracting a portion of the first media stream associated with the presentation surface, wherein the first media stream comprises a panoramic video stream of the communication session.

7. A method executed by a data processing system for conducting a communication session, the method comprising:
receiving, in connection with the communication session, a first media stream capturing a portion of an environment;
determining, via a processor and based on the received first media stream, that the environment includes a presentation surface;
detecting, via the processor and based on the received first media stream, content written or drawn on the presentation surface during the communication session;
in response to the detected content written or drawn on the presentation surface:
extracting the written or drawn content on the presentation surface from the received first media stream; and
generating a second media stream based on the extracted written or drawn content on the presentation surface; and
transmitting, to a remote device via a communication network, the second media stream including the extracted written or drawn content on the presentation surface.

8. The method of claim 7, further comprising:
detecting that visible content on the presentation surface has been cleared in the first media stream; and
stopping generating the second media stream including the extracted written or drawn content on the presentation surface responsive to the visible content on the presentation surface having been cleared.

9. The method of claim 7, further comprising:
detecting that visible content of the presentation surface has not been modified for a predetermined period of time since a previous usage of the presentation surface has been detected; and
stopping generating the second media stream including the extracted written or drawn content on the presentation surface responsive to a note-taking surface having not been used for the predetermined period of time.

10. The method of claim 7, wherein
detecting the content written or drawn on the presentation surface further comprises:
detecting an attentional focus of one or more participants of the communication session;
determining whether the attentional focus of at least one of the one or more participants of the communication session is directed toward the presentation surface; and
determining that the presentation surface is being used responsive to the attentional focus of at least one participant being directed toward the presentation surface.

11. The method of claim 7, wherein generating the second media stream further comprises:
determining that content of a region of the presentation surface is being obscured by an object or person;
identifying the content associated with the obscured region; and
overlaying a transparent representation of the object or person over a representation of the identified content associated with the region obscured by the object or person.

12. The method of claim 7, wherein generating the second media stream further comprises:
extracting a portion of the first media stream associated with the presentation surface, wherein the first media stream comprises a panoramic video stream of the communication session.

13. A memory device storing instructions that, when executed on a processor of a computing device, cause the computing device to conduct a communication session, by:
receiving, in connection with the communication session, a first media stream capturing a portion of an environment;
determining, based on the received first media stream, that the environment includes a presentation surface;
detecting, based on the received first media stream, content written or drawn on the presentation surface during the communication session;
in response to the detected content written or drawn on the presentation surface:
extracting the written or drawn content on the presentation surface from the received first media stream; and
generating a second media stream based on the extracted written or drawn content on the presentation surface; and
transmitting, to a remote device via a communication network, the second media stream including the extracted written or drawn content on the presentation surface.

14. The memory device of claim 13, further comprising instructions configured to cause the computing device to perform operations comprising:
detecting that visible content on the presentation surface has been cleared in the first media stream; and
stopping generating the second media stream including the extracted written or drawn content on the presentation surface responsive to the visible content on the presentation surface having been cleared.

15. The memory device of claim 13, further comprising instructions configured to cause the computing device to perform operations comprising:
detecting that visible content of the presentation surface has not been modified for a predetermined period of time since a previous usage of the presentation surface has been detected; and
stopping generating the second media stream including the extracted written or drawn content on the presentation surface responsive to a note-taking surface having not been used for the predetermined period of time.

16. The memory device of claim 13, wherein the instructions for detecting the content written or drawn on the presentation surface, further comprise instructions configured to cause the computing device to perform operations comprising:
detecting an attentional focus of one or more participants of the communication session;
determining whether the attentional focus of at least one of the one or more participants of the communication session is directed toward the presentation surface; and
determining that the presentation surface is being used responsive to the attentional focus of at least one participant being directed toward the presentation surface.

17. The memory device of claim 13, wherein the instructions for generating the second media stream further comprise instructions configured to cause the computing device to perform operations comprising:
determining that content of a region of the presentation surface is being obscured by an object or person;
identifying the content associated with the obscured region; and
overlaying a transparent representation of the object or person over a representation of the identified content associated with the region obscured by the object or person.

18. The memory device of claim 13, wherein the instructions for generating the second media stream further comprise instructions configured to cause the computing device to perform operations comprising:
extracting a portion of the first media stream associated with the presentation surface, wherein the first media stream comprises a panoramic video stream of the communication session.

19. The data processing system of claim 1, wherein to generate the second media stream, the executable instructions further comprise instructions configured to cause the processor to perform operations comprising:
segmenting at least a portion of the first media stream into a foreground portion, a background portion, and a presentation surface portion.

20. The data processing system of claim 1, wherein the executable instructions further comprise instructions configured to cause the processor to perform operations comprising:
detecting presence of the presentation surface using a deep convolutional neural network.
